(19) United States
(12) Patent Application Publication
(10) Pub. No.: US 2004/0017749 A1
(43) Pub. Date: Jan. 29, 2004

(54) Rewritable optical storage device with extended life

(75) Inventors: Jeffrey M. Brooke, Colorado Springs, CO (US); Johannes J. Verboom, Colorado Springs, CO (US); Robert Longman, Cambridge (GB); Robert Somekh, Cambridge (GB); Paul Blanchard, Hertfordshire (GB); Gary L. Kline, Colorado Springs, CO (US)

Correspondence Address: Oppenheimer Wolff & Donnelly LLP, 45 South Seventh Street, Suite 3300, Minneapollis, MN, 55402-1609, US

(73) Assignee: Plasmon LMS, Inc.

(21) Appl. No.: 10/202,285

(22) Filed: Jul. 24, 2002

(51) Int. Cl. G11B 7/00

(52) U.S. Cl. 369/47.51; 369/53.18

(57) ABSTRACT

In order to minimize potential damage to a rewritable storage media, and to consequently extend the life of the media, the laser power is carefully controlled in order to avoide sharp power transitions. Rather than simply turning the laser power on to its full power level, the power utilized during writing dedicated sections of data sectors is transitioned from 0 to its full power level over a desired period of time. In this way, the thermal shock caused by repeated rewriting in these areas can be minimized, thus extending the life of the rewritable media.

### BACKGROUND OF THE INVENTION

The present invention relates to storage devices which use rewritable optical storage media. More specifically, the present invention involves a system and method for extending the life of the rewritable optical media used in such storage systems, thus also extending the operable life of the storage device itself. Furthermore, the present invention necessarily also increases the life of a library which utilizes these storage devices.

As is clearly recognized by virtually all members of society, the use and storage of data for multiple applications is a critical component of day-to-day activities. The various applications that are using data continue to become more and more complex, thus utilizing larger amounts of data. Naturally, the storage and retrivability of this data is a critical function which must meet the capacity and speed needs of the related system or application. As is continuously seen in many areas of technology, there is a continued desire/demand for bigger and faster storage devices.

In recent years, optical storage devices have become increasingly well accepted for many storage needs This acceptance is due primarily to the speed and capacity that can be achieved using optical storage devices. Further, some optical storage devices are rewritable, thus making them even more versatile and powerful data storage options. With a rewritable optical storage device, the media itself is capable of existing in two different phases. Consequently, by configuring this media in a predetermined phase at desired locations, meaningful data can thus be stored. Due to the ability to reset the state of material, the storage device thus becomes rewritable and reusable.

As is recognized, the repeated writing in the same physical area to these rewritable optical disks can be detrimental. As with many physical devices, the localized changing of states in a very repetitive manner can cause thermal damage, thus making it ineffective. In operation, each writing step involves the heating of the media surface, and controlled cooling in order to achieve the desired state. This localized repeated heating and cooling is obviously harmful as it can cause damage to the media surface itself. At some point, the media becomes so damaged that it cannot be utilized for its intended purpose. In order to meet desired performance standards, storage device makers want to have increased life and high cyclability of the media. The current industry target is to obtain a storage system that will continue operating even after 1 million rewrites of data.

The most damage to the media surface is caused by the thermal shock created when write operations are initiated. Obviously, the sudden turn-on of a laser can cause severe damage to those locations. This is especially problematic if the same data is rewritten in the same location on the media. Specific areas of the data format are prone to this due to the repetitive nature of the recording (e.g. preambles and postambles). Protecting preambles and synchronization fields at the beginning of each sector from over-write damage is especially critical, because they are essential for PLL-capture and sector synchronization. A damaged preamble and synchronization field may lead to loss of a large chunk of data in the sector In the past, efforts have been made to minimize this damage by altering the start location for write operations. Specifically, some approaches have involved a random starting point, within a predetermined range or predetermined write area. This is recognized as the SPS approach (Start Position Shift) that is well known by those in the industry. Versions of this approach are shown in U.S. Pat. Nos. 6,091,698 and 6,128,260. Other approaches have involved the reconfiguration or recoding of data in order to alter patterns and rewrite only those portions of data which have actually changed.

While these approaches certainly have some benefit, they simply prolong the ultimate damage. Consequently, additional measures are desired to increase the useable life of an optical storage device.

### SUMMARY OF THE INVENTION

In order to extend the life of the rewriteable media, the present invention implements a method to minimize the thermal shock provided during writing operations. Specifically, the shock is minimized by tapering the write power during the initial portions of a write operation. Most often, this will involve the tapering of write power during a designated portion of the data sector immediately preceding the preamble. Additionally, the same tapering can be accomplished at the end of the data sectors (i.e., immediately following the postamble). In order to avoid interference with the various functions of the preamble and the postamble, separate guard fields are used for this power tapering function. Using these transitions will allow write power to be stable at its nominal value during writing of the preamble and postamble sections. Additional measures can also be taken to extend life such as SPS, and the international writing of marks on existing space and visa-versa.

In order to accomplish the desired power tapering, the power level must be appropriately controlled while writing to these guard fields. The actual power taper can have various characteristics and can be controlled to form many different wave forms, all in an effort to minimize this thermal shock. Obviously a straight line power taper, over a predetermined period of time, is the most straightforward and easiest to implement. Such a straight line taper does achieve the benefits of minimizing thermal shock.

In addition to the obvious benefits of the variable power approach, the methodology of the present invention can easily be implemented to complement other methodologies directed toward extending the life of the media. For example, the above-mentioned SPS approach could also be implemented along with the tapered power concept of the present invention.

Extending the life of the media also has a beneficial effect on related components and systems. For example, storage libraries utilize multiple storage devices, media, and appropriate media handling mechanisms to provide high capacity storage solutions. By extending media life, the related life of the library is also extended—media replacement and re-writing is necessarily minimized. Over time, this also has a beneficial effect on the storage media itself.

It is an object of the present invention to extend the life of the data media by minimizing the damage caused by continuous rewriting of repetitive data. It is a further object of the present invention to increase the potential rewriting cycles for the media, without compromising any data storage capabilities.

### BRIEF DESCRIPTION OF THE DRAWINGS

The above-mentioned objects and advantages can be further seen by reading the following detailed description in conjunction with the drawings in which:

FIG. 1 is a block diagram illustrating the basic components of an example data storage system;

FIG. 2 is a conceptual drawing illustrating the format of one data storage sector;

FIG. 3 is a graphical illustration of the power level used by the present invention; and

FIG. 4 is a block diagram of the actual data writing systems.

### DETAILED DESCRIPTION OF PREFERRED EMBODIMENTS

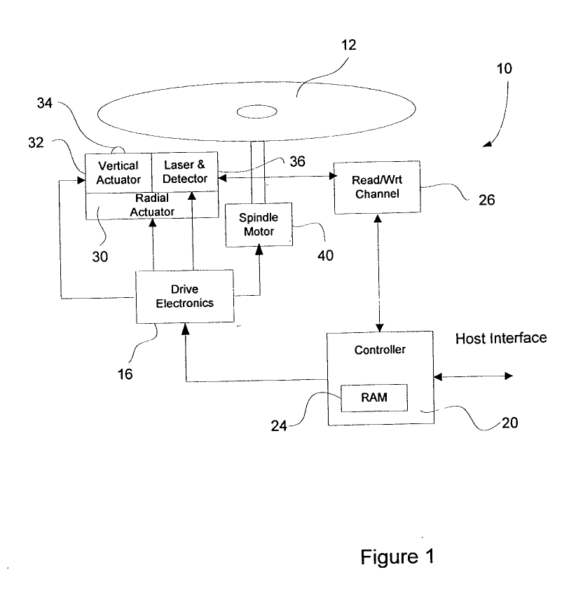

Referring now to FIG. 1, there is shown a schematic diagram of an exemplary disk storage system 10. The core component of storage system 10 is a rewritable optical media 12. Optical media 12 may include any well known rewritable optical disk, however, it may also be any type of rewritable media that may be damaged by continuous rewriting. Disk storage system 10, necessarily has a read/write system 14 incorporated therein for writing data to the optical media 12, and reading data therefrom. Storage system 10 further includes drive electronics 16 for operating the functions of the drive. Associated is a drive controller 20 which includes a memory or RAM 24. Interacting with the output from read/write head 14 is a read/write channel 26 which necessarily includes an internal decoder (now shown). Read/write channel 26 is capable of producing either decoded or non-decoded data and providing this data to controller 20. Controller 20 also communicates with a host system (not shown) to respond to its data storage and retrieval needs.

It will be understood that the system depicted in FIG. 1 is simply an example of hardware often found in data storage systems. Many variations could be incorporated into this component hardware and are all contemplated as being part of the present invention. Also, many additional functions may be undertaken by controller 20 or may be controlled by other components.

Read/write head 14 includes various components that are necessary for its operation. Specifically, a radial actuator 30 is included for accommodating radial motion for read/write system 14. Also, a vertical actuator 32 is included to move appropriate components closer to the surface of optical media 12 when necessary. For example, appropriate vertical motion (z axis) would be required for appropriate focusing. Vertical actuator 32 may also be referred to as a focus motor as it typically moves a focusing lens 34 into its optimum position. Lastly, read/write system 14 includes a laser and detector 36 for appropriately producing optical signals for use in either writing or reading to the optical media. Additionally, this laser and detector 36 cooperates with the light signals produced to detect data which has already been written to optical media 12.

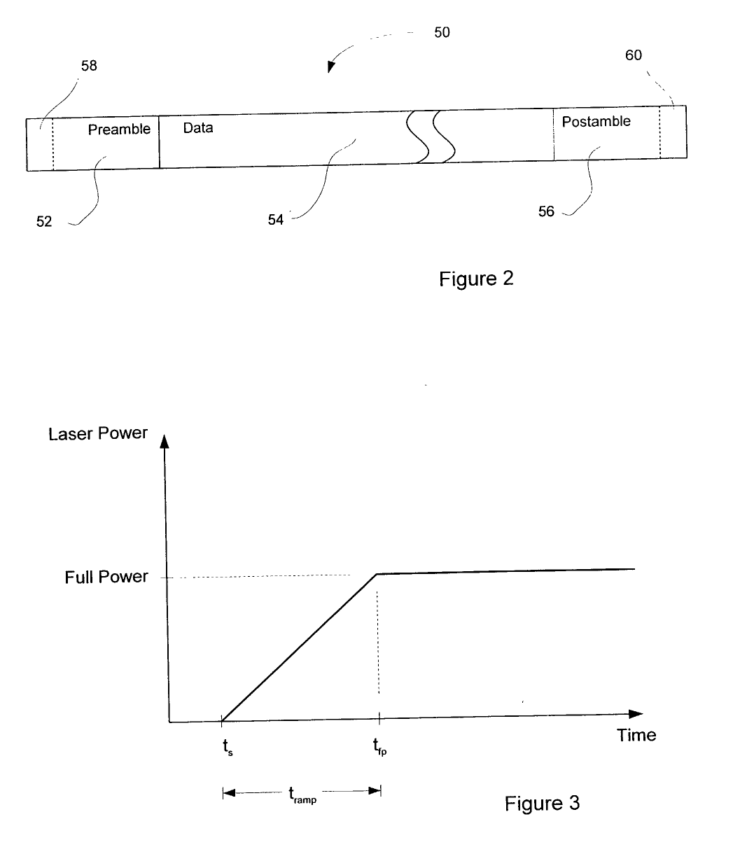

Referring now to FIG. 2, there is shown a graphical representation of a single data sector 50. The data sector itself includes a preamble region 52, a data storage area 54, and a postamble 56. As mentioned, this is one illustration of a typical data storage sector. It is understood that many variations could occur. As is well known by those skilled in the art, this sector is often incorporated into a larger data storage scheme which may include error correction provisions, etc. One such example is the standard data storage format for a DVD, or a CD ROM.

In order to extend the life of rewritable media, the present invention minimizes the thermal shock typically encountered by the data storage media. In typical data storage operations, using the format shown in FIG. 2, the preamble for a particular sector will often remain constant, while the actual information in data region 54 is more likely to change. Consequently, when rewriting this sector, the same information or data patterns are rewritten in preamble 52. Because the same areas are simply rewritten again and again, this causes the undesired stress on the media.

In order to minimize this stress, the systems within the data storage device of the present invention will incorporate a tapered power-on operation. One example of the power curve used by the present invention is shown in FIG. 3. This power curve illustrates the various power levels throughout the initial operation of the storage device. Obviously, laser power is kept at 0 until a writing operation is initiated. At a start time (t_{S}) the writing operation will start, causing the write power to begin tapering or ramping up to a full power level. At a predetermined time (t_{fp}) the laser is established or has reached its full power level. Consequently, the tapering will take place over a predetermined time period (tᵣₐₘₚ). From that time on, the laser is operated at its full power level.

The storage device of the present invention is coordinated so that this ramp or transition time period (tᵣₐₘₚ) operates during the writing of the guard field 58. Consequently, because the media is not being immediately “hit” with full power, the stress on the storage media is re-distributed. More specifically, a dedicated area or guard field 58 is utilized to taper write power. Guard field 58 is shown in FIG. 2 as a portion of the data sector immediately preceding preamble 52. Similarly, an ending guard field 60 is included immediately following postamble 56.

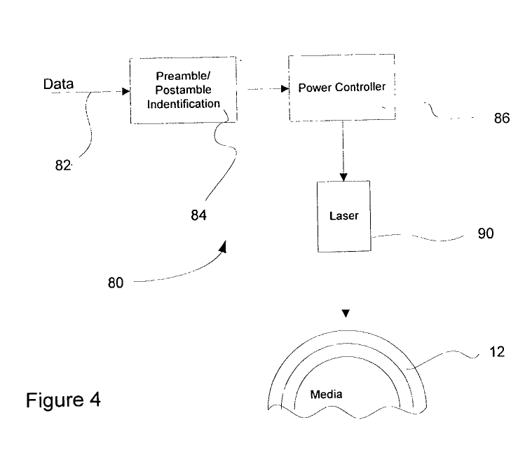

Referring now to FIG. 4, there is a shown a block diagram illustrating the functional components of the data storage system. In this embodiment, data is received on an input 82. In this case the data writing system 80 of the present invention includes a preamble/postamble identification device 84 along with a power controller 86, both of which are functionally attached to a laser 90. As is well known by those skilled in the art, laser 90 is appropriately positioned adjacent to a storage media 12 in order to appropriately write and read data. In this data writing system 80, the preamble/postamble identification system 84 identifies which region of the data sector is currently being written. Appropriate signals are then provided to power controller 86 along with the actual data, in order to appropriately actuate and control laser 90. Within power controller 86, the system will appropriately control the power level so that the above referenced tapering or ramping will occur during the preamble and postamble writing operations.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A method for writing data to an optical storage media using a write laser so as to prolong the life of a storage device utilizing the optical media, the method comprising:
initiating a write procedure upon receipt of a request to write data to the storage media; and
controlling a write laser so that power to the laser is ramped in a predetermined manner from a no power level to a predetermined full power level when writing to a dedicated area of the optical storage media, the dedicated area existing prior to the written data.

2. The method of claim 1 wherein the predetermined manner is a linear transition.

3. The method of claim 1 wherein the predetermined manner is a non-linear transition.

4. The method of claim 1 wherein the write procedure further comprises first determining a desired start location on the media where the write procedure is initiated.

5. The method of claim 4 wherein the desired start location is at a location immediately preceding a preamble section.

6. The method of claim 1 further comprising transitioning from the predetermined full power level to no power at a second dedicated area of the optical media, the second dedicated area located after the written data.

7. The method of claim 6 wherein the transitioning from the predetermined full power level to the no power level is a linear transition.

8. The method of claim 6 wherein the transitioning from the predetermined full power level to the no power level is a non-linear transition.

9. A method of minimizing damage to an optical storage media during writing operations, comprising:
initiating a write event by first locating a start position on the storage media to begin writing; and
controlling a write laser at the beginning of the write event such that a laser power level is ramped in a predetermined manner while writing to a region immediately adjacent the start position, further controlling the write laser so that the data is written at full laser power, and controlling the laser at the end of the write event so that the laser power level is also ramped in a second predetermined manner while writing the region immediately following the written data.

10. The method of claim 9 wherein the predetermined manner causes the write power level to begin at zero and linearly extend to a predetermined level in a predetermined period of time.

11. The method of claim 9 wherein the start position is located in a guard field.

12. The method of claim 9 wherein the predetermined manner causes the write power to transition from zero to a predetermined level in a non-linear fashion.

13. The method of claim 9 wherein the second predetermined manner causes the write power level to begin at zero and linearly extend to a predetermined level in a predetermined period of time

14. The method of claim 9 wherein the second predetermined manner causes the write power to transition from zero to a predetermined level in a non-linear fashion

15. A data storage device for storage of data as requested by a host computer, the data storage device comprising:
an optical storage media;
a controller operatively coupled to the host computer to receive a request to store data from the host computer and then initiate a write operation, the controller for further coordinating the transfer of data to the laser during the write operation; and
a laser for writing data to the storage media in response to the initiation of the write operation, wherein the laser will begin the write operation such that the laser power used during the write operation is transitioned from a start power level to a full write power level in a predetermined manner.

16. The data storage device of claim 15 wherein the predetermined manner is a linear transition.

17. The data storage device of claim 15 wherein the predetermined manner is a non-linear transition.

18. The data storage device of claim 15 wherein the data that is written during the transition from 0 power to full power is written to a dedicated section of the media.

19. The data storage device of claim 15 wherein the write operation writes data to a data sector which includes an initial guard field and a preamble, wherein the write operation begins in the initial guard field and the laser power transition occurs while writing to the initial guard field.

20. The data storage device of claim 15 wherein the laser is further controlled such that laser power is transitioned from the full write power to the start power level in a second predetermined manner at the end of the write operation.

21. The data storage device of claim 20 wherein the second predetermined manner is a linear transition.

22. The data storage device of claim 20 wherein the second predetermined manner is a nonlinear transition.

23. The data storage device of claim 20 wherein the write operation writes data to a data sector which includes a first guard field located ahead of a preamble, and a second guard field located after a postamble wherein the write operation begins in the first guard field and the laser power transitions will occur in the first guard field and the second guard field.

24. A data storage device for storage of data as requested by a host computer, the data storage device comprising:
an optical storage media;
a controller operatively coupled to the host computer to receive a request to store data from the host computer and then initiate a write operation, the controller for further coordinating the transfer of data to the laser during the write operation such that data is written to the optical storage media in a plurality of sectors, each sector including an initial guard field preceding a preamble; and
a laser for writing data to the optical storage media in response to the initiation of the write operation, wherein the write operation will begin by controlling the laser power used during the write operation such that power is transitioned from a start power level to a full writing power level in a predetermined manner while writing to the initial guard field.

25. The data storage device of claim 22 wherein the predetermined manner is a linear transition.

26. The data storage device of claim 22 wherein the predetermined manner is a non-linear transition.

27. The data storage device of claim 24 wherein the data sector further includes a final guard field following a postamble further wherein the laser power is controlled while writing to the final guard field such that laser power will transition from the full writing power to the start power level in a second predetermined manner.

28. The data storage device of claim 27 wherein the second predetermined manner is a linear transition.

29. The data storage device of claim 27 wherein the second predetermined manner is a nonlinear transition.
